(19) United States
(12) Patent Application Publication
(10) Pub. No.: US 2016/0281205 A1
(43) Pub. Date: Sep. 29, 2016

(54) Ceramic Coated Articles and Manufacture Methods

(71) Applicant: UNITED TECHNOLOGIES CORPORATION, Farmington, CT (US)

(72) Inventor: Christopher W. Strock, Kennebunk, ME (US)

(73) Assignee: United Technologies Corporation, Farmington, CT (US)

(21) Appl. No.: 15/035,351

(22) PCT Filed: Oct. 22, 2014
(86) PCT No.: PCT/US2014/061710

§ 371 Date: May 9, 2016

Related U.S. Application Data
(60) Provisional application No. 61/904,247, filed on Nov. 14, 2013.

(51) Int. Cl. C23C 4/134; C23C 4/02; F23R 3/00; F01D 5/28; F01D 9/02; F01D 11/08; C23C 4/12; C23C 4/11

(52) U.S. Cl. CPC C23C 4/134; C23C 4/12; C23C 4/02; C23C 4/11; F01D 5/282; F01D 9/02; F01D 11/08; F23R 3/002; F05D 2230/312; F05D 2300/20; F05D 2300/175; F05D 2220/32

(57) ABSTRACT

A method comprises: thermal spray (416) of a first ceramic layer; sol infiltration (420) of ceramic particles into the first ceramic layer; and after the sol infiltration, thermal spray (434) of a second ceramic layer atop the first ceramic layer.

### CROSS REFERENCE TO RELATED APPLICATION

Benefit is claimed of U.S. patent application Ser. No. 61/904,247, filed Nov. 14, 2013, and entitled “Ceramic Coated Articles and Manufacture Methods”, the disclosure of which is incorporated by reference herein in its entirety as if set forth at length.

### BACKGROUND

The disclosure relates gas turbine engines. More particularly, the disclosure relates to thermal barrier coatings for gas turbine engines.

Gas turbine engine gaspath components are exposed to extreme heat and thermal gradients during various phases of engine operation. Thermal-mechanical stresses and resulting fatigue contribute to component failure. Significant efforts are made to cool such components and provide thermal barrier coatings to improve durability.

Exemplary thermal barrier coating systems include two-layer thermal barrier coating systems. An exemplary system includes NiCoCrAlY bondcoat (e.g., low pressure plasma sprayed (LPPS)) and an yttria-stabilized zirconia (YSZ) thermal barrier coat (TBC) (e.g., air plasma sprayed (APS) or electron beam physical vapor deposited (EBPVD)). Prior to and while the barrier coat layer is being deposited, a thermally grown oxide (TGO) layer (e.g., alumina) forms atop the bondcoat layer. As time-at-temperature and the number of cycles increase, this TGO interface layer grows in thickness. An exemplary YSZ is 7 weight percent yttria-stabilized zirconia (7YSZ).

US2003/0152814 discloses a thermal barrier coating wherein a strain-tolerant columnar grain ceramic (e.g., 7YSZ) is applied by EB-PVD followed by air plasma spray or low pressure plasma spray of an insulative layer (e.g., yttria-ceria). U.S. Pat. No. 7,306,859 discloses EB-PVD of YSZ to form a columnar layer followed by plasma spray to form a non-columnar layer that is relatively thick along the platform surface of a blade.

Exemplary TBCs are applied to thicknesses of 1-40 mils (0.025-1.0 mm) and can contribute to a temperature reduction of up to 300° F. (167° C.) at the base metal. This temperature reduction translates into improved part durability, higher turbine operating temperatures, and improved turbine efficiency.

### SUMMARY

One aspect of the disclosure involves a method comprising: thermal spray of a first ceramic layer; sol infiltration of ceramic particles into the first ceramic layer; and, after the sol infiltration, thermal spray of a second ceramic layer atop the first ceramic layer.

A further embodiment may additionally and/or alternatively include the first ceramic layer being atop a Ni-based superalloy substrate.

A further embodiment may additionally and/or alternatively include the first ceramic layer being atop a metallic bondcoat and the metallic bondcoat being atop the substrate.

A further embodiment may additionally and/or alternatively include the first ceramic layer having a characteristic thickness of 10 micrometers to 100 micrometers and the second ceramic layer having a characteristic thickness of 50 micrometers to 300 micrometers.

A further embodiment may additionally and/or alternatively include the first ceramic layer and the second ceramic layer comprising yttria-stabilized zirconia.

A further embodiment may additionally and/or alternatively include the sol infiltration being a pressure infiltration or a vacuum infiltration.

A further embodiment may additionally and/or alternatively include the sol infiltration being of agglomerates having an average size of less than 200 nanometers of individual particles having an average particle size of less than 20 nanometers.

A further embodiment may additionally and/or alternatively include the first ceramic layer being characterized by splat interface gaps and shrinkage cracks and said particles within said gaps and cracks and the second ceramic layer being characterized by splat interface gaps and shrinkage cracks and substantially no ceramic particles within said gaps and cracks.

A further embodiment may additionally and/or alternatively include the first ceramic layer being characterized by modulus, strength, and toughness parameters and the second ceramic layer being characterized by lower respective modulus, strain, and toughness parameters than those of the first ceramic layer.

A further embodiment may additionally and/or alternatively include an article produced by any of the foregoing methods.

Another aspect of the disclosure involves an article comprising a substrate. A first layer is atop the substrate and characterized by: a first ceramic material having splat interface gaps and shrinkage cracks; and a second ceramic material as agglomerated particles coating surfaces of said splat interface gaps and shrinkage cracks. A second layer is atop the first layer and is characterized by splat interface gaps and shrinkage cracks.

A further embodiment may additionally and/or alternatively include the first ceramic being a YSZ and the second ceramic material being essentially pure zirconia.

A further embodiment may additionally and/or alternatively include the first layer first ceramic material being a plasma-sprayed material and the second layer being a plasma-sprayed material.

A further embodiment may additionally and/or alternatively include the second ceramic material being of agglomerates having an average size of less than 200 nanometers of individual particles having an average particle size of less than 20 nanometers.

A further embodiment may additionally and/or alternatively include the first layer being characterized by modulus, strength, and toughness parameters and the second layer being characterized by lower respective modulus, strain, and toughness parameters than those of the first ceramic layer.

A further embodiment may additionally and/or alternatively include the first layer having a characteristic thickness of 10 micrometers to 100 micrometers and the second layer having a characteristic thickness of 50 micrometers to 300 micrometers.

A further embodiment may additionally and/or alternatively include a bondcoat between the substrate and the first layer.

A further embodiment may additionally and/or alternatively include the substrate being a Ni-based superalloy substrate.

A further embodiment may additionally and/or alternatively include the article being a gas turbine engine component.

A further embodiment may additionally and/or alternatively include the article being a gas turbine engine blade, vane, combustor panel or blade outer air seal.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a partially schematic sectional view of substrate having a coating.

FIG. 2 is a partially schematic view of a vane bearing the coating as a thermal barrier coating (TBC).

FIG. 3 is a partially schematic view of a blade bearing the TBC.

FIG. 4 is a partially schematic side view of a blade outer air seal (BOAS) bearing the coating as an abradable coating and facing a blade tip.

FIG. 5 is a flowchart of a process for coating the substrate of FIG. 1.

FIG. 6 is a photomicrograph of a section of a precursor of a first ceramic layer of the coating of FIG. 1 and a bondcoat therebelow.

Like reference numbers and designations in the various drawings indicate like elements.

### DETAILED DESCRIPTION

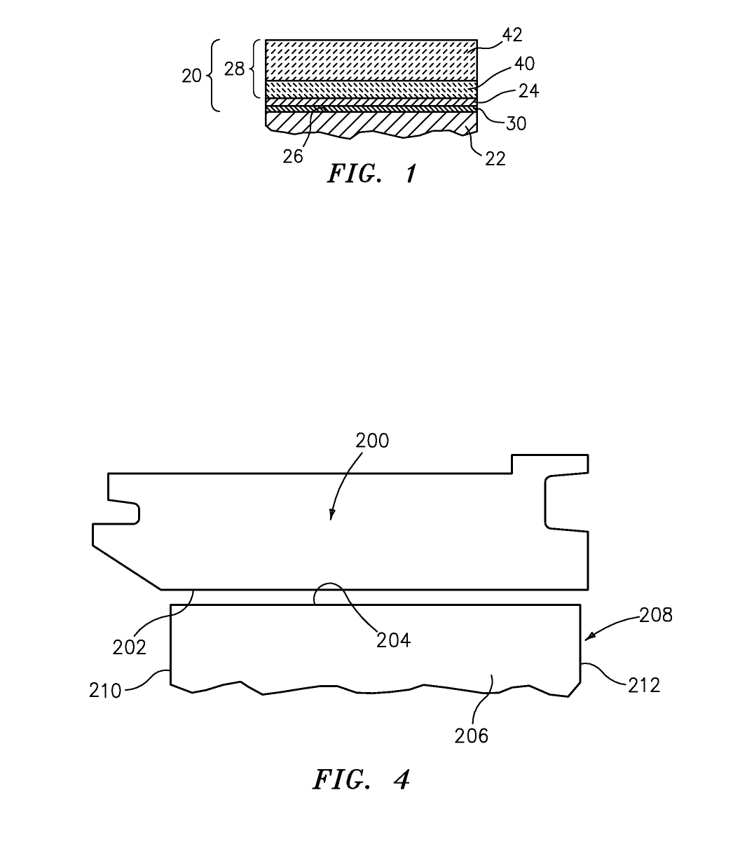

FIG. 1 shows a coating system (e.g., a thermal barrier coating system) 20 atop a metallic substrate 22. In an exemplary embodiment, the substrate is a nickel-based superalloy or a cobalt-based superalloy such as a cast component (e.g., a single crystal casting) of a gas turbine engine. Exemplary components are hot section components such as combustor panels, turbine blades, turbine vanes, and airseals. One particular alloy is PWA 1484. Alternative materials include metal matrix composites (MMC) and non-metallic materials including monolithic ceramics and ceramic matrix composites (CMC).

The coating system 20 may include a bondcoat 30 atop a surface 26 of the substrate 22. A thermal barrier coating (TBC) 28 is atop the bondcoat or substrate. A thermally grown oxide (TGO) layer 24 may form at the interface of the bondcoat to the TBC.

The TBC is a multi-layer TBC with at least two layers. A first layer 40 is a lower layer. A second layer 42 is over the first layer. In the exemplary system, the TBC consists of or consists essentially of the first and second layers (e.g., subject to relatively small gradation/transition with each other and with the bondcoat (if any) as noted above).

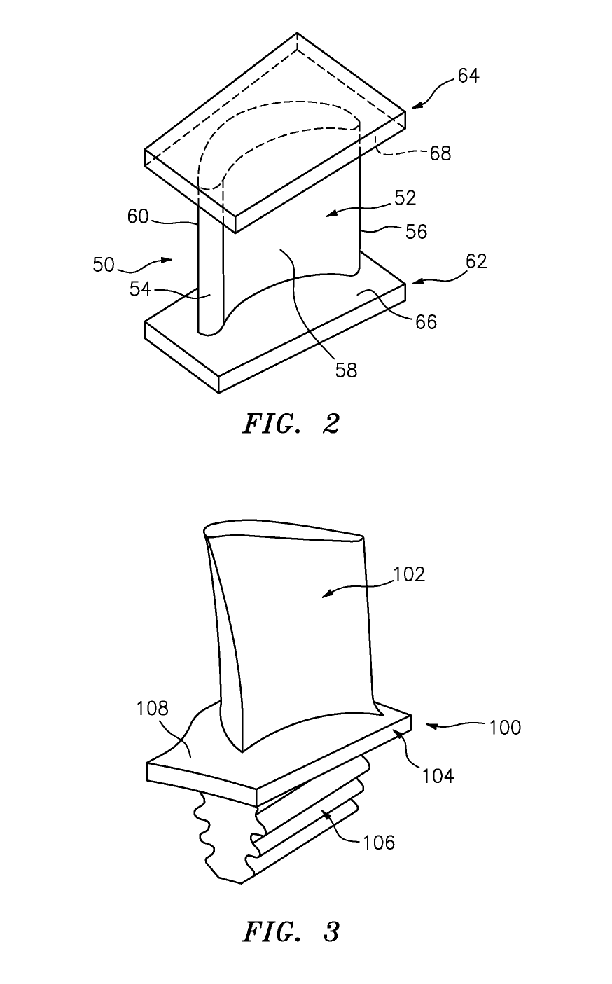

FIG. 2 shows a vane 50 comprising the cast metallic substrate 22. The vane includes an airfoil 52 having a surface comprising a leading edge 54, a trailing edge 56, a pressure side 58, and a suction side 60. The airfoil extends from an inboard end at a platform or band segment 62 to an outboard end and an outboard shroud or band segment 64. The segments 62 and 64 have respective gaspath surfaces 66 and 68. These are essentially normal to the airfoil surfaces. The TBC system extends at least along the surface of the airfoil and the surfaces 66 and 68.

As is discussed further below, the first layer 40 is formed by thermal spray of a ceramic to form a precursor of the layer 40 followed by infiltration of particles of one or more other ceramics (which may be similar or dissimilar to the chemical composition of the precursor).

Exemplary materials for the precursor of layer 40 and layer 42 may be of similar nominal composition (e.g., 7YSZ) or may be of differing nominal compositions.

Exemplary particulate material for the infiltrant comprises particles of one or more of zirconia, yttria, gadolinia, hafnia, alumina, and the like (either as particles of separate materials or particles of combinations of these materials). An exemplary first layer precursor composition and second layer composition is a YSZ or a gadolinia-stabilized zirconia (GSZ) or a mixture thereof.

The exemplary bondcoat 30 is a metallic bondcoat such as an overlay bondcoat or a diffusion aluminide. An exemplary MCrAlY overlay bondcoat is PWA 1386 NiCoCrAlYHfSi. This may be applied by low-pressure plasma spray (LPPS) among several possibilities. Alternative bondcoats are gamma/gamma prime and NiAlCrX bondcoats and may be applied via processes further including cathodic arc and ion plasma. Exemplary bondcoat thicknesses are 2-500 micrometers, more narrowly, 12-250 micrometers or 25-150 micrometers on average.

FIG. 3 shows a blade 100 having an airfoil 102 extending outward from a platform 104. The blade includes an attachment root 106 inboard of the platform. The platform 104 has an outboard gaspath surface 108 which may be subject to similar coating considerations relative to the airfoil 102 as the surfaces 66 and 68 are relative to the airfoil 52. Yet alternative articles and coating locations include the hot sides of combustor panels and other hot section components. Additionally, use may be as an abradable or rub coating such as on the inner diameter (ID) surface of a blade outer air seal (BOAS). Examples of combustor panels and BOAS are found in U.S. Pat. No. 8,535,783, the disclosure of which is incorporated by reference in its entirety herein as if set forth at length.

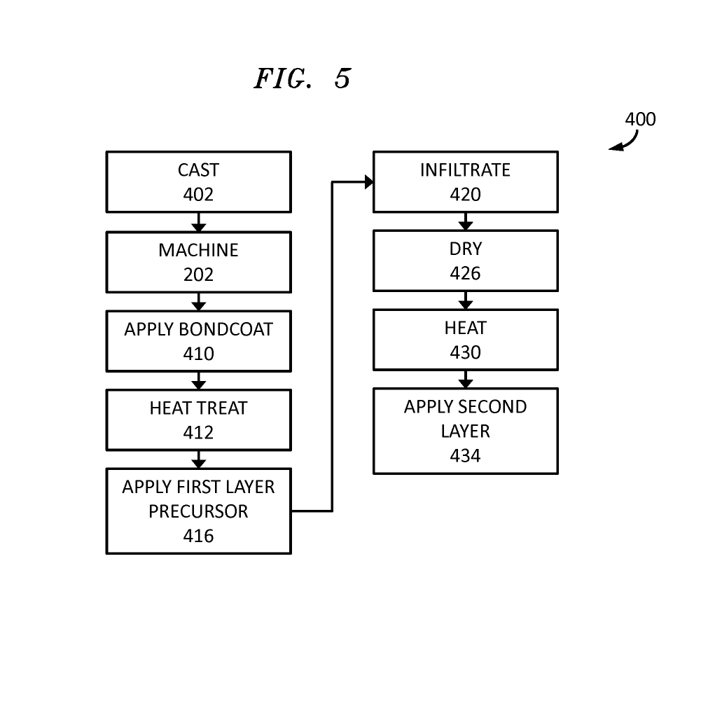

For example, FIG. 4 shows a BOAS segment 200 having a gaspath-facing inner diameter (ID) surface 202 on which the coating system 20 is formed as an abradable coating. The surface 202 is in close facing proximity to tips 204 of airfoils 206 of blades 208. The airfoils extend from a leading edge 210 to a trailing edge 212 and have a respective pressure side and suction side.

In an exemplary sequence 400 (FIG. 5) of manufacture, the substrate is formed (e.g., by casting 402 followed by machining 404 and surface treatment (e.g., grit blasting) 406).

The bondcoat 30 may be deposited 410 (e.g., an MCrAlY bondcoat such as a CoNiCrAlY applied by high velocity oxy-fuel (HVOF) deposition. Bondcoat deposition may be followed by diffusion heat treatment 412 (e.g., for one hour at 1975° F. (1079° C.)).

The first layer 40 precursor may be applied 416. Exemplary application is by thermal spray (e.g., by air plasma spraying of thin-walled hollow spherical particles until the desired coating thickness is deposited).

Prior art toughened interface ceramic coatings have been known to be processed with substrate temperature of 1000° C. or higher. The high substrate temperature results in enhanced fusion of coating material droplets as they are deposited. As a result, increased strength, modulus and toughness are achieved. This high part temperature is difficult to achieve in a production environment, may be detrimental to the properties of the base metal, and may add significant cost and complexity to the manufacturing process.

In contrast to the high deposition temperature prior art toughened interface thermal barrier coating, the part temperature during deposition of the first layer is kept low. Exemplary maximum part temperature is less than 500° F. (260° C.), more particularly, less than 400° F. (204° C.), and more broadly, less than 800° F. (427° C.) or less than 600° F. (316° C.). This substrate temperature in combination with normal spray parameters result in inter-particle bonding that produces a low modulus and strain tolerant coating. These conditions may also be used in the second layer of the disclosed coating.

Exemplary as-applied first layer precursor thickness is 0.5 mil to 3 mils (13 micrometers to 80 micrometers, more broadly 10 micrometers to 100 micrometers and more narrowly, 20 micrometers to 50 micrometers). This forms a conventional air plasma sprayed coating structure as is well known in the art. Characteristic features of this type of coating include an interconnected porosity that includes splats, microcracks and splat boundaries. In one example, the as-applied first layer precursor has about a 12% porosity (including splat boundary gaps, cracks, globular voids, and other pores).

The gaps, cracks, and pores are formed during the deposition of solid, molten and partially molten particulate coating material. Each of the incoming particles, heated and propelled toward the surface by the hot gas stream emanating from the spray torch, deform upon impact with the part surface to form a splat of coating material. The splat is flattened coating material that has cooled and adhered to the surface. Some unmelted particles are also typically deposited, retaining some or all of the original particle morphology.

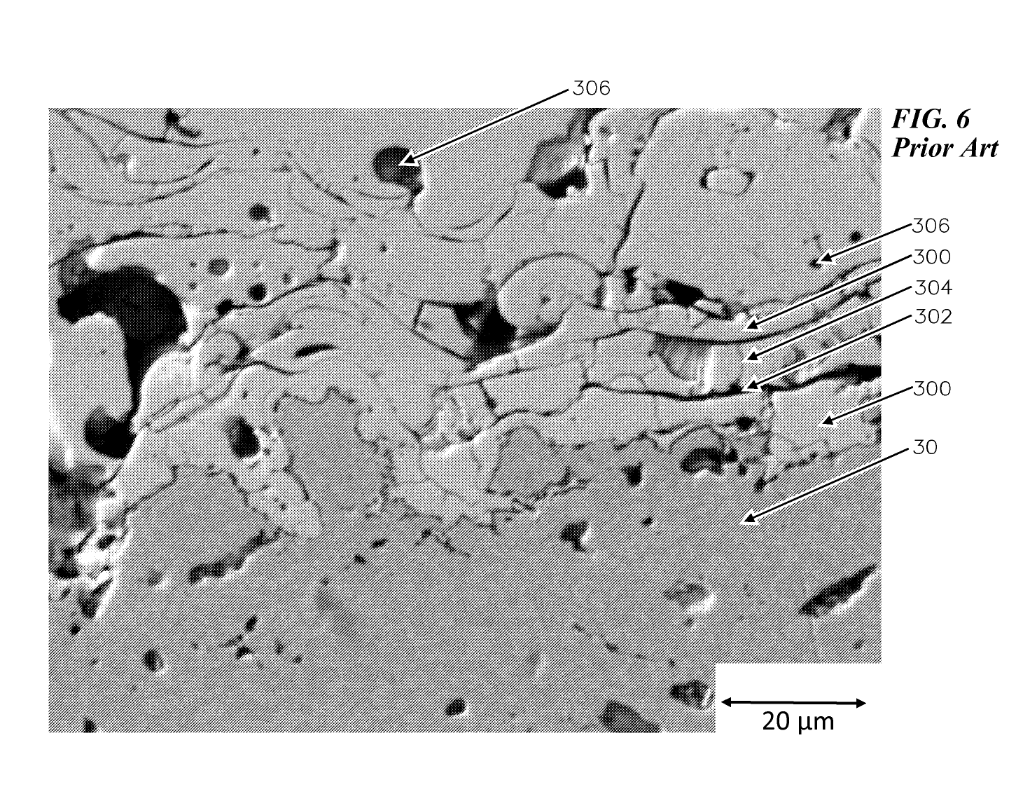

FIG. 6 shows one example of an as-applied first layer precursor showing the bondcoat 30 with layers of splats 300 built up thereupon. Inter-splat boundary gaps are shown as 302. Cooling cracks within the splats are shown as 304. Additional bulk globular pores are shown as 306. The splats are connected to the bondcoat surface by both fusion and mechanical interlocking. The splat's connection to the bondcoat surface or prior deposited coating particles is not complete, leaving the aforementioned inter-splat boundaries, laminar and globular porosity. Also, the significant shrinkage due to solidification and cooling results in the aforementioned through-thickness micro-cracks 304 in the splats. Combined, these defects result in a coating that has substantially reduced elastic modulus and strength compared with the fully dense material from which it is made. These defects result in the desirable strain tolerance that allows ceramic materials to survive as coatings on metallic substrates and contribute toughness to the material through crack deflection and the internal friction between the many interfaces present. However, there are limitations to the abilities of such coatings and further toughening may be desired. Accordingly, an infiltration process is used to further toughen the coating.

The first layer precursor is then infiltrated 420 with the infiltrant (e.g., a ceramic sol). A sol is a suspension of particles in a liquid. The particles remain suspended over a useful time period. The term “sol” should be read as inclusive of both liquid sols and sol-gels. A sol-gel typically has cross-linking between the solid particles to provide enhanced stability and altered viscosity characteristics. Exemplary sol is of zirconium oxide (zirconia). Exemplary particle size is 20 nm to 200 nm. Exemplary viscosity is 20 Pascal second (Pa*s) (more broadly, 15 Pa*s to 25 Pa*s or 10 Pa*s to 50 Pa*s). These particles may be agglomerates of smaller individual particles (e.g., individual particles of less than 20 nm or less than 10 nm characteristic size). One exemplary material is available from Nissan Chemical America Corporation of Houston, Tex. under the trademark NanoUse ZR. Such material is an aqueous suspension of 30 nm to 100 nm agglomerates of nominal 7 nm zirconia particles. This is diluted with deionized water to form a reduced viscosity sol at approximately 25% solids by weight for use in the infiltration. Such material is described in U.S. Pat. No. 8,058,318. The sol will infiltrate the boundary gaps 302 and cracks 304 and may further infiltrate the globular pores 306.

The infiltrated first layer may be dried either as a separate step 426 (e.g., ambient or hot air dry or oven bake) or as part of later heating. Infiltration and drying may be repeated to achieve a desired amount of infiltration.

Relative to its pre-infiltration condition, the first layer 40 has a slightly reduced porosity, an increased modulus, and increased strength and toughness. An exemplary decrease in porosity as measured by percentage of the coating's original porosity, is by 1% to 20% (more narrowly, 5%-15% or, more broadly, 1% to 30%) (e.g., a coating density increase or porosity reduction of 0.1% to 2.4% (more narrowly, 0.6% to 1.8%) with the nominal 12% original porosity example).

The ceramic material deposited within the precursor's porosity or defect structure not only increases the coating's density, but also affects the bonding between adjacent pieces of the cracked coating and relative motion of pieces. The very small size of the particles of the sol allow it to infiltrate the micro-cracks 304 and inter-splat laminar porosity 302 of the coating. In these spaces the fine particles can coat the walls of the cracks and other porosity and either fully bridge the gaps or add surface texture that acts to increase the interlocking of adjacent surfaces. The infiltrant particles naturally bond to each other and to surfaces at room temperature and will further increase their bonding upon heating (e.g., heating for drying, heating caused by the second layer application, and/or in-use heating) and will sinter at relatively low temperature due to their very small size. When the modified first layer is put under stress, the increased interparticle bonding and increased frictional forces at crack and splat interfaces result in increased strength and fracture toughness. The increase in strength and toughness need only be minimal to achieve increased coating spallation resistance, however desired strengthening and toughening is on the order of 50% to 100% increase while with some precursor coating layers greater increases may be beneficial.

The infiltration and drying process may slightly increase the thickness of the first layer 40 relative to its as-sprayed precursor. For example, the sol will be expected to coat not merely internal surfaces but the upper surface of the precursor. Accordingly, depending on the implementation, this may result in the apparent presence of a slight intermediate layer of relatively small thickness and consisting of the sol ceramic. Exemplary hypothetical thickness is less than 6 micrometers, more particularly, less than 4 micrometers or less than 2 micrometers. At the lower end of this range, this will not provide a discrete continuous layer but would rather provide the localized coating on the intact outer surface of the precursor while leaving gaps associated with the cracks, etc.

The infiltrated first layer may then be heated 430 as a preheating for application 434 of the second layer 42. Exemplary preheating is by a plasma torch to be used in applying the second layer. Preheating serves to drive off any remaining solvent or adsorbed moisture prior to application of additional coating and promotes adhesion of the second coating layer.

The exemplary second coating layer may be similar to or dissimilar to the first layer precursor in composition or application methods/parameters. Generally, a GSZ (gadolinia stabilized zirconia) or YSZ (yttria stabilized zirconia) may be used. In one particular example, it is the same YSZ (e.g., 7YSZ) (7wt % yttria stabilized zirconia) as used for the first layer precursor and applied using the same methods and parameters. As-applied second layer thickness for TBC use is 0.006 inch to 0.024 inch (150 micrometers to 0.61 mm), more broadly 0.004 inch to 0.030 inch (100 micrometers to 0.76 mm) and more narrowly, 0.008 inch to 0.016 inch (0.22 mm to 0.41 mm). For use as an abradable coating, exemplary thickness is 0.012 inch to 0.060 inch (0.30 mm to 1.5 mm).

An exemplary combined/total thickness of both ceramic layers is from 0.002-0.020 inch (0.05-0.5 mm) (more particularly, 0.005-0.016 inch (0.13-0.41 mm)).

Such exemplary thicknesses of various layers may be a local thickness or an average thickness (e.g., mean, median, or modal).

In further variations, there may be a sintering step. The exemplary sintering step may be performed either with or after the drying, as part of the preheating 430, or even after the application 434 of the second layer 42. Exemplary sintering involves heating to a temperature effective to cause bonding between the particles deposited by the sol. Exemplary temperature is, on an absolute temperature scale, at least about half the melting point of the sol particles and is limited to the melting point or other temperature capability limit of the bondcoat and/or base metal.

An alternative to a sol of agglomerated particles is a sol of non-agglomerated particles (a monodispersed sol). Exemplary particle size for such a sol is up to about 200 nm, more narrowly, up to 100 nm and an exemplary 10 nm to 100 nm.

Accordingly, if the same material and deposition parameters are used both for the first layer precursor and the second layer, the second layer will have a greater porosity than the first layer. The difference in this porosity may thus be the aforementioned density increase or porosity reduction (e.g., a 0.1% to 2.4% net porosity difference). More narrowly, the porosity of the second layer may exceed the porosity of the first layer by at least 0.5% porosity, particularly, at least 0.6% porosity. However, it may be desirable to have yet a greater porosity in the second layer than even in the first layer precursor (e.g., for yet lower thermal conductivity or greater abradability). As one such example, an alternate second coating layer may be applied using a fugitive porosity former to yield a final porosity of 15% to 26% (see, U.S. Pat. No. 4,936,745).

Alternatively characterized, the second layer may have a lower amount (if any) of infiltrated ceramic particles within the aforementioned gaps 302, cracks 304, and pores 306 than does the first layer. An exemplary content of such particles in the second layer relative to the first layer is less than half by weight or volume, more narrowly, less than 25% by weight or volume, or less than 10% by weight or volume. Alternative gadolinia-stabilized zirconia (GSZ) compositions for one or both layers are shown in U.S. Pat. No. 6,117,560.

The desirability of increasing the modulus of the first layer via infiltration may seem counterintuitive. A lower modulus base layer would be expected to be advantageous to accommodate differential thermal expansion between the metallic substrate and the ceramic coating. However, the increased modulus is for only a thin first layer which causes only a minor increase in stress at the ceramic to bondcoat interface. This increased stress is offset by the strengthening and toughening in this local first layer region where the stresses are highest, thus the benefit of increased toughness outweigh the detriment of the locally increased modulus.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

1. A method comprising:
thermal spray (416) of a first ceramic layer;
sol infiltration (420) of ceramic particles into the first ceramic layer; and
after the sol infiltration, thermal spray (434) of a second ceramic layer atop the first ceramic layer.

2. The method of claim 1 wherein:
the first ceramic layer is atop a Ni-based superalloy substrate (22).

3. The method of claim 2 wherein:
the first ceramic layer is atop a metallic bondcoat (30) and the metallic bondcoat is atop the substrate.

4. The method of claim 1 wherein:
the first ceramic layer has a characteristic thickness of 10 micrometers to 100 micrometers; and
the second ceramic layer has a characteristic thickness of 50 micrometers to 300 micrometers.

5. The method of claim 1 wherein:
the first ceramic layer and the second ceramic layer comprise yttria-stabilized zirconia.

6. The method of claim 1 wherein:
the sol infiltration is a pressure infiltration or a vacuum infiltration.

7. The method of claim 1 wherein:
the sol infiltration is of agglomerates having an average size of less than 200 nanometers of individual particles having an average particle size of less than 20 nanometers.

8. The method of claim 1 wherein:
the first ceramic layer is characterized by splat (300) interface gaps (302) and shrinkage cracks (304) and said particles within said gaps and cracks; and
the second ceramic layer is characterized by splat interface gaps and shrinkage cracks and substantially no ceramic particles within said gaps and cracks.

9. The method of claim 1 wherein:
the first ceramic layer is characterized by modulus, strength, and toughness parameters; and
the second ceramic layer is characterized by lower respective modulus, strain, and toughness parameters than those of the first ceramic layer.

10. An article produced by the method of claim 1.

11. An article comprising:
a substrate (22);
a first layer (40) atop the substrate and characterized by:
a first ceramic material having splat (300) interface gaps (302) and shrinkage cracks (304); and
a second ceramic material as agglomerated particles coating surfaces of said splat interface gaps and shrinkage cracks; and
a second layer (42) atop the first layer and characterized by splat interface gaps and shrinkage cracks.

12. The article of claim 11 wherein:
the first ceramic material is a YSZ; and
the second ceramic material is essentially pure zirconia.

13. The article of claim 11 wherein:
the first layer first ceramic material is a plasma-sprayed material; and
the second layer is a plasma-sprayed material.

14. The article of claim 11 wherein:
the second ceramic material is of agglomerates having an average size of less than 200 nanometers of individual particles having an average particle size of less than 20 nanometers.

15. The article of claim 11 wherein:
the first layer is characterized by modulus, strength, and toughness parameters; and
the second layer is characterized by lower respective modulus, strain, and toughness parameters than those of the first layer.

16. The article of claim 11 wherein:
the first layer has a characteristic thickness of 10 micrometers to 100 micrometers; and
the second layer has a characteristic thickness of 50 micrometers to 300 micrometers.

17. The article of claim 11 further comprising:
a bondcoat between the substrate and the first layer.

18. The article of claim 11 wherein:
the substrate is a Ni-based superalloy substrate.

19. The article of claim 11 wherein:
the article is a gas turbine engine component.

20. The article of claim 11 wherein:
the article is a gas turbine engine blade, vane, combustor panel or blade outer air seal.
